(19) United States
(12) Patent Application Publication
(10) Pub. No.: US 2002/0175665 A1
(43) Pub. Date: Nov. 28, 2002

(54) Integrated battery and media decoder for a portable host device, and methods of operating and manufacturing the same

(76) Inventors: Gerald William O'Grady, Co. Wicklow (IE); Mark Ainsley Jacob, Malahide (IE); Conor Thomas Ryan, Dublin (IE); Sean Patrick Mitchell, Phibsborough (IE)

Correspondence Address: Andre L. Marais, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/993,868

(22) Filed: Nov. 5, 2001

Related U.S. Application Data
(63) Continuation of application No. PCT/US01/25777, filed on Aug. 17, 2001.
(60) Provisional application No. 60/226,459, filed on Aug. 17, 2000.

(51) Int. Cl. H05F 1/00

(52) U.S. Cl. 323/371

(57) ABSTRACT

An integrated accessory for a host device includes a media decoder, a battery coupled to the media decoder operationally to provide power to the media decoder, and a connector to couple the accessory to a host device. Within the integrated accessory, the battery is coupled to the connector so as to allow the battery operationally to provide power to the host device, in addition to the media decoder. In one embodiment, the battery, the media decoder and the connector are integrated within a housing that is configured to be removably coupled to the host device. The host device may be a portable device (e.g., a notebook computer, PDA, a mobile phone, a wristwatch, a camera, etc.).

### CROSS REFERENCE TO RELATED APPLICATIONS

This application is a continuation of PCT application PCT/US01/25777, filed Aug. 17, 2001, which claims the benefit of U.S. Provisional Application No. 60/226,459, filed Aug. 17, 2000.

### FIELD OF THE INVENTION

The present invention pertains generally to the fields of power supply and media decoding and, more specifically, to a battery pack for a portable host device that includes an integrated audio or video decoder.

### BACKGROUND OF THE INVENTION

The popularity of portable devices (e.g., mobile telephones, personal digital assistants (PDAs), notebook computers, cameras etc.) has been fueled by the increased mobility of people within the workplace and the convenience of continual access to information and communications networks (e.g., the Public Switched Telephone Network (PSTN) and the Internet). A large majority of such portable devices rely upon batteries as a power source. Many modem batteries incorporate electronics to monitor the health of the battery, manage charging, etc.

### SUMMARY OF THE INVENTION

According to a first aspect of the present invention, there is provided an integrated accessory for a host device. The accessory includes a media decoder, a battery coupled to the media decoder operationally to provide power to the media decoder, and a connector to couple the accessory to a host device. Within the integrated accessory, the battery is coupled to the connector so as to allow the battery operationally to provide power to the host device, in addition to the media decoder. In one embodiment, the battery, the media decoder and the connector are integrated within a housing that is configured to be removably coupled to the host device.

The host device may be a portable device (e.g., a notebook computer, PDA, a mobile phone, a wristwatch, a camera, etc.).

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating the first exemplary embodiment of an integrate accessory for a host device, the integrated accessory including both a media decoder and a battery.

FIG. 2 is a block diagram illustrating a second exemplary embodiment of an integrated accessory for a host device, the integrated accessory again including both a battery and a media decoder, the media decoder exhibiting a higher degree of integration with peripherals than to the exemplary embodiment illustrated in FIG. 1.

FIG. 3 is a block diagram illustrating further architectural details of a media decoder in the exemplary form of an audio decoder, and more specifically a DSP core, which may be included within any one of the integrated accessories shown in FIGS. 1 and 2.

FIG. 4 is a flow chart illustrating a method, according to an exemplary embodiment of the present invention, of operation of an integrated accessory, and provides details regarding interactions between the integrated accessory and a host device.

FIG. 5 is a block diagram illustrating an exemplary embodiment of the present invention wherein the power-supply accessory operates as a battery pack, including an integrated media player, for a host device in the exemplary form of a mobile telephone.

### DETAILED DESCRIPTION

An integrated battery and media decoder for a portable host device, and methods of operating and manufacturing the same, are described. In the following description, for purposes of explanation, numerous specific details are set forth in order to provide a thorough understanding of the present invention. It will be evident, however, to one skilled in the art that the present invention may be practiced without these specific details.

For the purposes of the present invention, the term “battery” shall be taken to include any self-contained power supply that is capable of supplying power without being continually coupled to a power supply network.

At a high level, the present invention proposes a power-supply accessory for a host device (e.g., a portable host device) that includes both the media decoder (e.g., a MP3 player) and a battery. The battery is coupled to the media decoder to operationally provide power to the media decoder. The power-supply accessory also includes a connector to removably couple the power-supply accessory to the host device. The battery within the power-supply accessory is in turn coupled to the connector, so as to allow the battery operationally to provide power to the host device.

The host device, in one embodiment, is a portable host device, and may be any one of a number of portable host devices, such as a mobile telephone, a personal digital assistant (PDA), a notebook computer, a wristwatch, a camera, etc. For the purposes of illustration, the below description describes the host device as being a mobile phone, the media decoder as being an audio decoder, and the power-supply accessory as being a battery pack for such a mobile phone. It will of course be appreciated that the invention is not limited to such exemplary devices and applications.

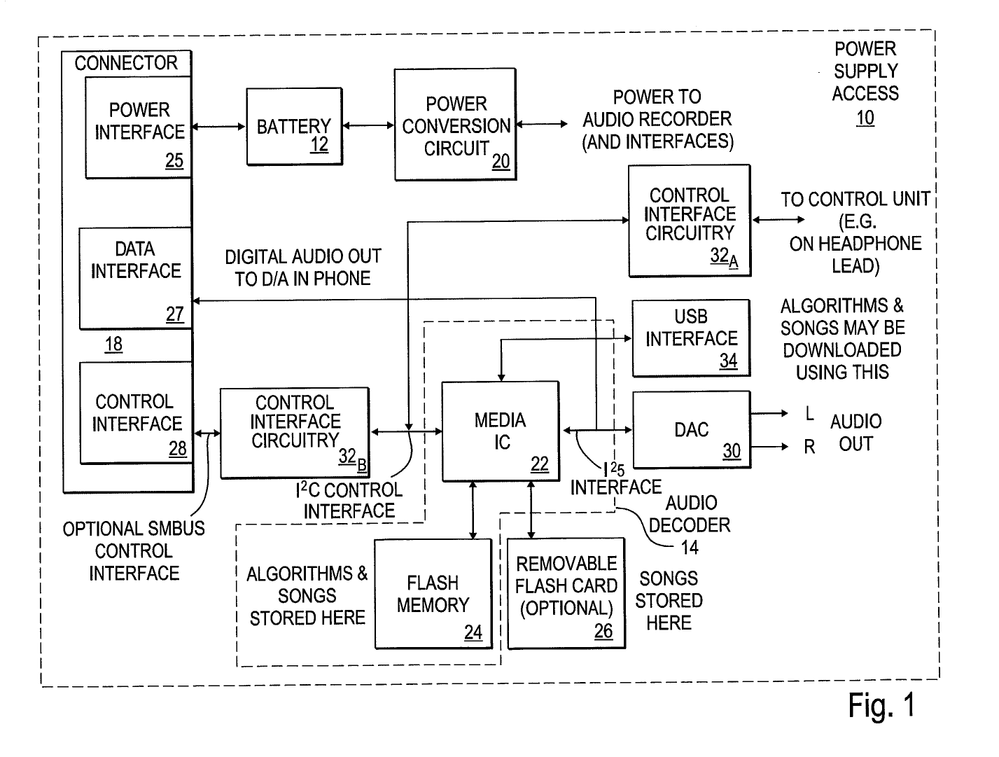

FIG. 1 is a block diagram illustrating a power-supply accessory 10, according to a first exemplary embodiment of the present invention. The illustrated components of the power-supply accessory are, in one embodiment, integrated within a housing that is configured to be removably coupled to a host device in the exemplary form of a mobile telephone. The power-supply accessory 10 is shown to include a power supply in the form of a battery 12, a media decoder in the exemplary form of an audio decoder 14 and a connector 18 to facilitate the removable coupling of the power-supply accessory 10 to a host device.

The battery 12 may be any one of a number of battery types typically included within battery packs for multiple devices (e.g., a NiCad, NiMh, alkaline or lithium battery). The battery 12 is shown to be coupled to the connector 18 so as to allow the battery operationally to provide power to the mobile telephone. The battery 12 is also shown to be coupled to a power conversion circuit 20 so as to allow the battery operationally to provide power to the audio decoder 14. The power requirements for the mobile telephone and the audio decoder may be different, and the power conversion circuit 20 operates to adjust voltage levels outputted from the battery 12 to a level appropriate to power the audio decoder 14. The output of the power conversion circuit 20 may also be utilized to power the interface and other illustrated peripheral components of the power-supply accessory 10.

The audio decoder 14 is shown to include a media integrated circuit (IC) 22 that in one embodiment incorporates a Digital Signal Processor (DSP) core (discussed in further detail below) and an embedded, non-volatile memory in the form of a FLASH memory 24. In one exemplary embodiment, the media IC 22 may be the MediaStream chip 111, designed by Parthus Technologies PLC of Dublin, Ireland, the chip supporting access of up to 128 MB of NAND flash memory. The FLASH memory 24 stores both a collection of media decompression algorithms in the exemplary form of audio decompression algorithms, as well as compressed media files in the exemplary form of compressed audio files. Examples of such audio decompression (or decoding) algorithms include the MP3 decompression algorithm, based on the Fraunhofer Institute Implementation, the Advanced Audio Coding (AAC) algorithm based on the Fraunhofer Institute Implementation, the Microsoft Windows Media Decoder, the Qdesign Audio Decoder and the Audible.com audio decoder. The stored and compressed audio files (not shown) may be decompressed or decoded, for example, by any one of the above mentioned decompression (or decoding) algorithms. As the FLASH memory 24 is programmable, the audio decoder 14 may conveniently be upgraded to support a wide range of compression of technologies.

The power-supply accessory 10 is also shown to include removable memory in the exemplary form of a removable FLASH memory card 26. In one embodiment, the media IC 22 supports the MultiMediaCard (MMC) and SmartMedia formats. Other formats that may be supported by the media IC 22 include the SD and Memory Stick formats. The removable FLASH memory card 26 is shown, in the exemplary embodiment, to store audio files.

The media IC 22 executes system software, uploaded from the FLASH memory 24 on boot up, that implements a file system on both the FLASH memory 24 and the removable FLASH memory card 26, whereby audio files are stored in directories (e.g., similar to directories on a personal computer, with which the reader may be familiar).

The audio decompression algorithms stored within the FLASH memory 24 are stored in an area of the memory 24 that is not visible to the user. As will be described in further detail below, under direction of a mobile telephone, the media IC 22 loads an appropriate audio decompression algorithm for a selected audio file from the FLASH memory 24, and awaits further instructions provided via the mobile phone to the media IC 22.

As described above, the audio decoder 14 stores and executes system software (e.g., the MediaStream Platform 1000 system software developed by Parthus Technologies PLC). This system software may implement a master/slave protocol that facilitates data communications between the audio decoder 14 and the host device. More specifically, the data communications may include commands that are provided from the host device to the audio decoder 14 to, for example, control operation of the audio decoder 14. The commands may also include parameter set commands to set parameters of the audio decoder 14, and parameter read commands to read parameters of the audio decoder 14. Further examples are provided below. For example, the host device may interrogate the audio decoder 14 for its current status, request information regarding a next audio file type, load an appropriate decoder to decode a specific audio file type, play the audio file, pause playing of the audio file, stop playing of the audio file, skip to the next audio file, etc. Commands may also be provided from the host device to adjust volume and tone, as well adjusting the parameters of any effects algorithms that may be present.

A discussion now follows regarding the connector 18. The connector 18 provides various interfaces between the host device and the power-supply accessory 10. Referring to the exemplary embodiment of the present invention shown in FIG. 1, the connector 18 provides three interfaces, namely a power interface 25 whereby the battery 12 operationally provides power to the host device, a data interface 27 whereby a digital audio data is outputted from the audio decoder 14 to a digital-to-analog converter (not shown) within the host device, and a control interface 28 via which commands and other instructions are communicated between the host device and the audio decoder 14. The power interface 25 may adjust the power supply to suitable voltage levels for the host device.

Digital audio output from the audio decoder 14 is shown to be provided to both the data interface 27 of the connector 18 for supply to a DAC within the host device, and to a DAC 30 that is included within the power-supply accessory 10. The output of the audio data to the data interface 27 and the DAC 30 is, in one embodiment, via an I²S Bus. The DAC 30 operates to convert the digital audio output from the audio decoder 14 to an analog signal that may be outputted via a jack connector (not shown) to headphones. In one embodiment, the outputs of the DAC 30 is provided to an output amplifier (not shown) that buffers the outputs of the DAC 30 to allow these outputs to drive the headphones.

The exemplary power-supply accessory 10 accordingly provides two options for outputting audio (or other media) to a user. In a first case, the digital audio output from the audio decoder 14 is fed from the power-supply accessory 10 to the host device via the data interface 27 of the connector 18. This digital audio as received by the host device may then be combined with other digital audio (e.g., telephone call audio) from the host device itself. This allows a single headphone set to be plugged into a jack of the host device. In the exemplary embodiment in which the host device is a mobile telephone, the user can accordingly listen to music and make/receive telephone calls via this single jack. For example, when an incoming call arrives or the user wishes to make a telephone call, the mobile telephone may mute the digital audio output received from the power-supply accessory 10, and route the telephone call audio to the headset. When the call is terminated, or when commanded by the user, the mobile telephone may route audio output received from the power-supply accessory 10 to the headset.

In a second case, the DAC 30 that is integral with the power-supply accessory 10 outputs an analog audio signal that is supplied to a jack connector integral within the power-supply accessory 10 for headphones.

Data communications between the audio decoder 14 and the control interface 28 of the connector 18 are, in the exemplary embodiment, performed via an I²C control bus which is shown in FIG. 1 to couple the audio decoder 14 to control interface circuitry 32ₐ, which enables an external controller (e.g., associated with a headset) to control operation of the audio decoder 14. The power-supply accessory 10 may also optionally include control interface circuitry 32_{b} through which the audio decoder 14 communicates with the control interface 28 via a SMBUS bus.

The exemplary embodiment of the power-supply accessory 10 shown in FIG. 1 also includes a Universal Serial Bus (USB) interface 34, coupled to a USB jack, via which algorithms and songs may be downloaded to, or uploaded from, the audio decoder 14 and the removable FLASH memory card 26.

Audio files may be downloaded to (or uploaded from) the power-supply accessory 10 in a number of ways. Firstly, such audio files may be downloaded (or uploaded) via the host device (e.g., a mobile telephone). For example, it is possible to upload and download compressed audio files from the Internet utilizing a mobile telephone. Although a relatively slow data transfer rates are achievable utilizing current mobile telephones, the next generation of mobile telephones (e.g., G3 telephones) provide a much higher data transfer rate, making this option more attractive.

Secondly, audio files may be communicated with the power-supply accessory 10 via the USB interface 34, for example utilizing a personal computer with an appropriate interface. This option allows for the very rapid transfer of audio files. It will be appreciated that the USB interface 34 is optional within the accessory 10, as the physical construction of the power-supply accessory 10 may not allow the inclusion of the USB interface 34.

Thirdly, audio files may be made accessible to the audio decoder 14 via the removable FLASH memory card 26. For example, the removal FLASH memory card 26 may be programmed externally, inserted into the power-supply accessory 10, and files then transferred from the FLASH memory card 26 to the internal FLASH memory 24.

The physical design of the power-supply accessory 10 is of course dependent on the host device, as different host devices will place appropriate constraints, or allow certain freedoms, with respect to the physical design. Considering for example a mobile telephone where the power-supply accessory 10 operates as a battery pack, two basic physical designs for such battery packs are currently in common usage. A first physical design is designed to be inserted within a housing of the mobile telephone, and a separate cover is attached to the phone to protect the battery. In one embodiment where the power-supply accessory 10 is designed according to the specifications of such a battery pack, physical access to the power-supply accessory 10 when installed is not practical. Accordingly, in this case, the USB interface 34 and the DAC 30 may be omitted from the power-supply accessory 10, as direct access is not feasible.

A second physical design currently employed is one in which a battery pack forms part of the case of the handset when inserted into the mobile telephone. Direct access to such a battery pack is operationally feasible. In this case, where the power-supply accessory 10 conforms to the specifications of such a battery pack, jacks for providing access to the USB interface 34 and the DAC 30 may be included within the power-supply accessory 10.

Power management is an important consideration for mobile applications. Accordingly, a platform supported by the media IC 22 provides low power consumption (e.g., less than 70 mw while playing). In one embodiment, the audio decoder 14 requires a power supply voltage of 1.8 and 3.3V DC, which may be provided by the power conversion circuit 20.

A media platform supported by the media IC 22 may provide a number of power-savings modes that may be entered into under software control to reduce overall power consumption. For example, system software executed by the media IC 22 may implement “wait”, “stop” and “power down” states. Each mode removes a clock signal from successively larger portions of the power-supply accessory 10 until, in the “power down” mode, an external crystal amplifier is disabled to completely remove a clock source to the accessory 10. All three modes of operation may be entered into under control of the system software. The “wait” and “stop” modes may be exited on the occurrence of a hardware reset, a debug request, or an unmasked interrupt. The “power down” mode may only be exited by a hardware reset.

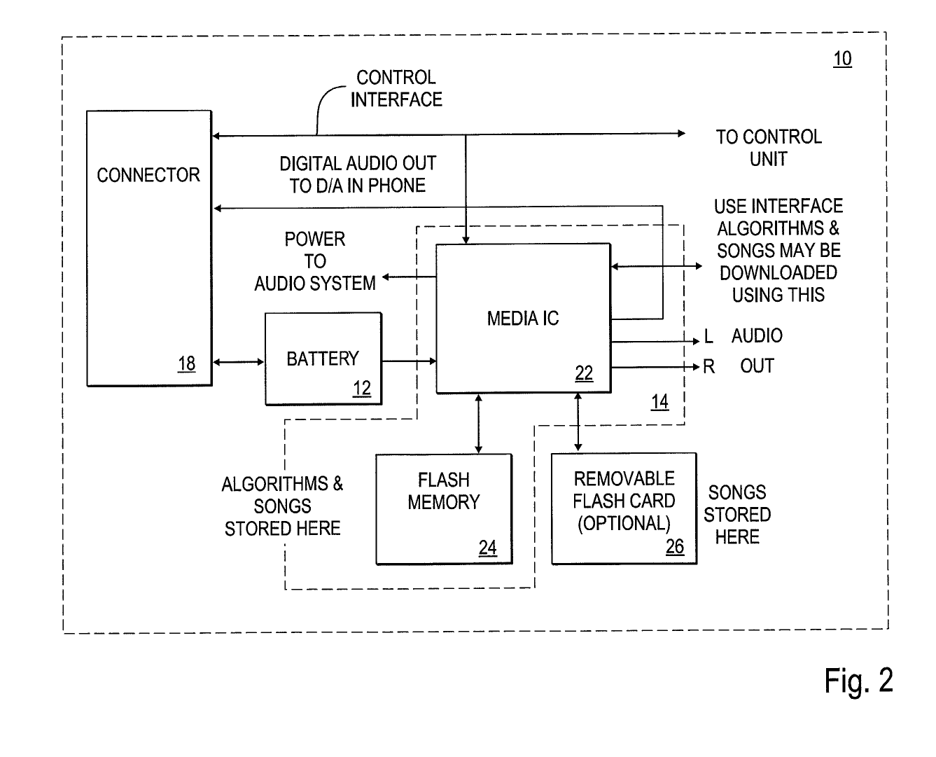

FIG. 2 is a block diagram illustrating a second exemplary embodiment of the power-supply accessory 10, which differs from the embodiment illustrated in FIG. 1 in that the FIG. 2 embodiment provides a more highly integrated solution. Specifically, a number of the peripheral components of the FIG. 1 embodiment (e.g., the USB interface 34, the DAC 30, the power conversion circuit 20 and the control interface circuitry 32) are integrated on-chip within the media IC 22, and are accordingly not separately illustrated. It will however be appreciated that the function of the FIG. 2 embodiment is substantially similar to the FIG. 1 embodiment.

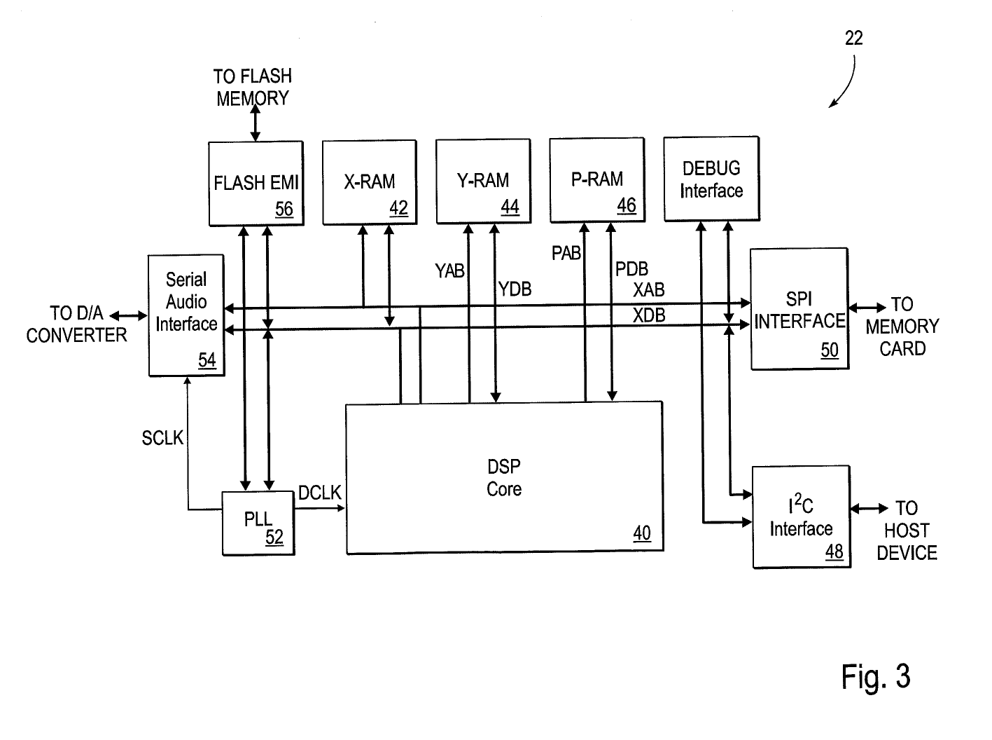

FIG. 3 is a block diagram providing further architectural details regarding the media IC 22, according to an exemplary embodiment of the present invention. Central to the media IC 22 is a DSP core 40 (e.g., the DSP 2410 programmable DSP core designed by Parthus Technologies PLC). Benefits associated with the use of a programmable DSP core 40 (as opposed to a hardware-based architecture) for compressed audio decoding include the use of a programmable memory that facilitates the convenient updating of decoding algorithms and control software. For example, DSP program code may be stored within the FLASH memory 24 and uploaded by the DSP core 40 on power-up. This allows for updates as audio decompression standards evolve and for new audio decoding algorithms to be included within the power-supply accessory 10 as these become available. Further, additional effects algorithms (e.g., 3-D surround sound) may conveniently be added.

Various peripherals are provided around the DSP core 40 to implement the audio decoder 14. Specifically, X-RAM, Y-RAM and Program-RAM 42, 44 and 46 support the DSP core 40. A control interface in the exemplary form of an I²C interface 48 facilitates communication with a control unit within a host device (e.g., a mobile telephone). A Serial Peripheral Allow Interface 50 facilitates communications with the removable FLASH memory card 26. A Phase Locked Loop (PLL) provides clock signals for the power-supply accessory 10. A Serial Audio Interface (SAI) 54 is utilized to stream decompressed audio from the media IC 22, in the manner described above, to a data interface 27 of the connector 18, and eventually on to an external DAC incorporated within a host device for conversion to an analog signal to drive headphones.

A FLASH External Memory Interface (EMI) allows the media IC 22 to connect to external memory (e.g., NAND flash and standard SRAM/NOR FLASH memory). This facilitates access to compressed audio files and audio decoder algorithms. Access may also be provided via this interface, for example, to a number of interesting applications, such as applications implementing post-processing effects (e.g., surround sound).

The above-described peripherals allow the DSP core 40 to function as a digital bit-stream compressed audio decoder 14.

In a further embodiment, the media IC 22 may also include a Sony/Phillips Digital Interface Format (SPDIF) interface that allows the power-supply accessory 10 to connect to other devices (e.g., compact disk (CD) players) that support this interface.

With respect to the above-mentioned SAI interface 54, while this interface is most commonly used in output mode, because this interface 54 is under program control in the embodiment illustrated in FIG. 3, the interface 54 may also be set to operate in an input mode. Therefore, by the addition of an external A/D converter, the media IC 22 may be used as an audio encoder, accepting digital audio from the A/D converter. The media IC 22 may then convert such received digital audio into a compressed audio format (e.g., MP3) and then store a resulting compressed audio file within the FLASH memory 24. This feature may be implemented to provide voice/memo record capability within the power-supply accessory 10.

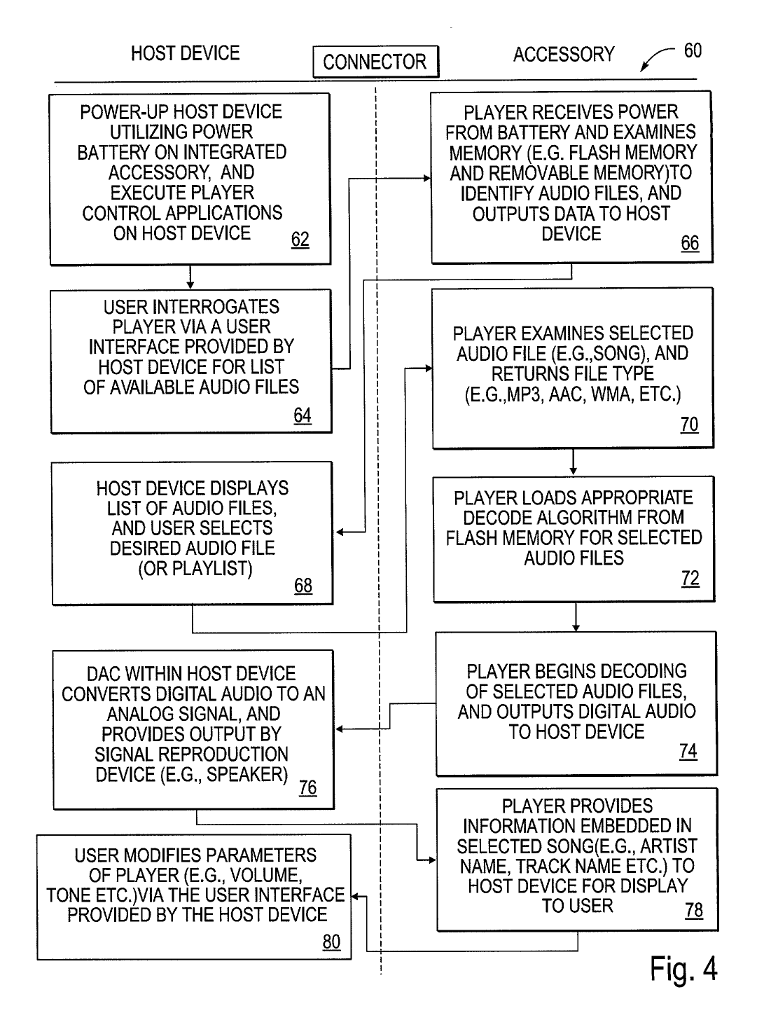

FIG. 4 is a flow chart illustrating a method 60, according to an exemplary embodiment of the present invention, of operation of the power-supply accessory 10. FIG. 4 also illustrates the interactions between a host device (e.g., a mobile telephone) and the power-supply accessory 10.

The method 60 commences at block 62 with the booting (or power-up) of a host device, this power-up being performed utilizing power received from the battery 12 via the connector 18. The host device then executes a media player control application that may be utilized to control a media player (e.g., the audio decoder 14) within the power-supply accessory 10.

At block 64, a user of the host device may interrogate the media player via a user interface provided on the host device for a list of available media (e.g., audio) files that are accessible to the media player. For example, where the host device comprises a mobile telephone, the media player control application may provide a “list songs” function that is user-selectable to facilitate the interrogation at block 64.

At block 66, the media player receives power from the battery 12 via the power conversion circuit 20, examines memory (e.g., the FLASH memory 24 and/or the removable FLASH memory card 26) to locate and identify audio files, and outputs data to the host device identifying the located audio files. It will be appreciated that the communication of data between the host device and the power-supply accessory 10 that occurs at blocks 64-66 is, in one embodiment, performed via the control interface 28.

At block 68, the host device then displays a list of audio files on a display screen (e.g., a LCD screen of a mobile telephone) to the user. The user then selects one or more desired audio files (or a play list) utilizing a input device (e.g., a numeric key pay) of the host device. The identifiers for the selected audio files are then communicated, via the control interface 28 of the connector 18, back to the media player (e.g., the audio decoder 14) within the power-supply accessory 10.

At block 70, the media player that examines the selected audio files, and returns file type (e.g., MP3, AAC, WMA, etc.) information identifying compression algorithms whereby the respective audio files have been encoded.

At block 72, the media player then loads appropriate decode algorithms from the FLASH memory 24 for the selected audio files. At block 74, the media player begins decoding of the selected audio files utilizing the loaded decode algorithms, and outputs digital audio to the host device. Referring specifically to FIG. 1, in this embodiment, the digital audio is outputted from the audio decoder 14 via the data interface 27 of the connector 18. It will also be appreciated that the digital audio may be outputted via the I²S interface to the DAC 30 for direct output from the accessory 10.

At block 76, a DAC (not shown) within the host device converts the digital audio signal into an analog signal, and provides output via a signal reproduction device (e.g., headphones or a speaker) coupled to the host device.

At block 78, the media player provides information embedded within a selected audio file (e.g., song and artist name, etc.) to the host device via the control interface for display to a user.

At block 80, the user may optionally modify parameters of the media player (e.g., the volume, tone, etc. of the digital output of the audio decoder 14) via a user interface provided by the host device.

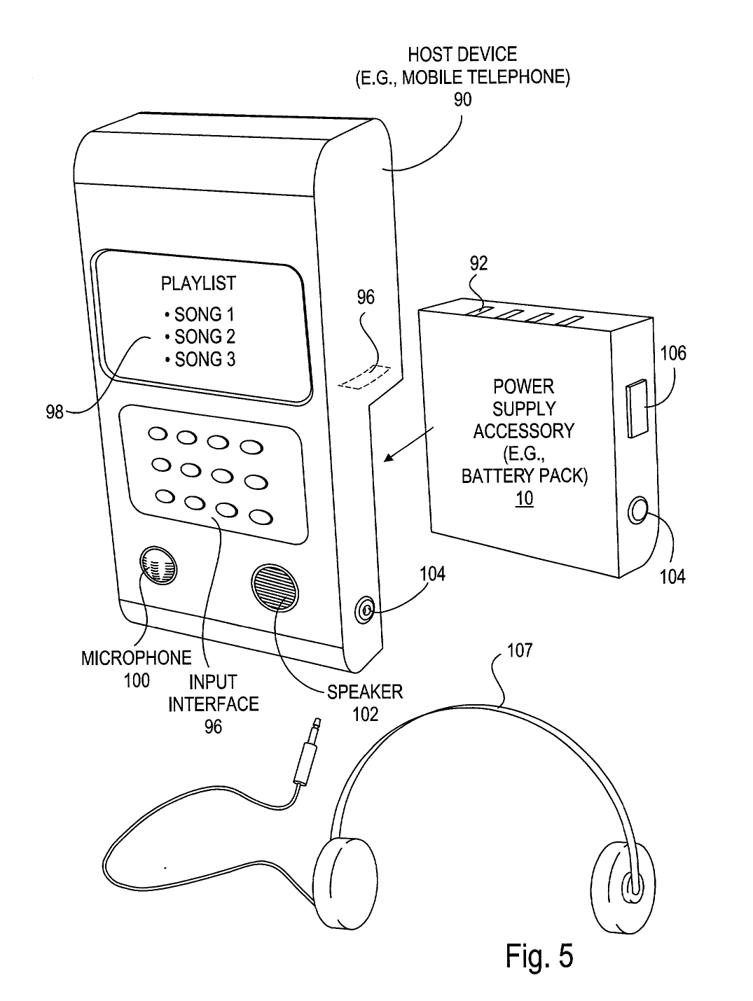

FIG. 5 is a block diagram illustrating an exemplary embodiment of the present invention wherein the power-supply accessory 10 operates as a battery pack, including an integrated media player, for a host device in the exemplary form of a mobile telephone 90. As illustrated, the power-supply accessory 10 includes a housing within which components are integrally housed, and which includes the connector 18 to facilitate removable coupling of the power-supply accessory 10 to the mobile telephone 90. The power-supply accessory 10 is also shown to include a number of plated contacts, coupled to the connector 18. Contact is maintained by spring pressure (or bias) between contacts 94 (shown in broken line) of the mobile telephone 90 and contacts 92 of the power-supply accessory 10.

The mobile telephone 90 is also shown to include an input interface 96 (e.g., a numeric keyboard, a QWERTY keyboard, a touch pad or the like) and a display interface 98 (e.g., a LCD screen) utilizing which the user can interact with the mobile telephone 90 and the power-supply accessory 10, and be provided with additional information.

The mobile telephone 90 may also include a data input device, in an exemplary form of a microphone 100 or a camera (not shown), and a signal reproduction device in an exemplary form of a speaker 102 or video screen (not shown).

The mobile telephone 90 and the power-supply accessory 10 are each shown to include a jack via which a media signal (e.g., an audio or video signal) may be outputted from the respective component to, for example, a pair of headphones, shown at 106. The power-supply accessory 10 is also shown to include a high-speed data port 107 (e.g., a USB or FireWire jack).

The incorporation of a media player (e.g., the audio decoder 14) within a power-supply accessory 10 (e.g., a battery pack) as illustrated in FIG. 5 is particularly advantageous in that a host device (e.g. the mobile telephone 90) typically includes an input interface (e.g., numeric key pad) and an output interface (e.g., a LCD display or speaker) that can be leveraged to control the media player as integrated within the power-supply accessory 10. Accordingly, costs associated with producing a media player, which leverages existing components in a host device, can be reduced relative to products where such interfaces must be incorporated within the product.

While an audio decoder 14 has been held out as an example of a media player for illustrative purposes in the above exemplary embodiments, it will be appreciated that the media player need not necessarily be an audio decoder (or audio player). Specifically, the media player may include broader functionality, and be capable of decoding (and encoding) both audio and video signals. For example, the media player may operate as both an audio and video encoder and decoder. In these cases, an appropriate input device of a host device may be utilized to provide input to such a media player, and to reproduce output from such a media player. For example, where a media player within a power-supply accessory 10 is capable of processing video data, a camera (e.g., a digital video camera) included within the host device may be utilized to provide data to the media player for encoding and storage. Similarly, a video display (e.g., a LCD) included within the host device may be utilized to reproduce video signals decoded by, and received from, a media player within the power-supply accessory 10.

For the purposes of illustration, a number of exemplary media player operation commands in the form of MP3 commands that may be provided from a player control application, executing on the host device and provided to the media player within an power-supply accessory 10, are provided in Table 1. Each MP3 status/command variable may be accessed as a single word parameter, and is addressed by an offset supplied by the host device. The MSB of each command is a DSP application number, and in this example, the relevant media player in the form of a MP3 player has been designated an application number of 1.

TABLE 1

| | Coding(hex) | | Response(hex) |
|---|---|---|---|
| Command | app:cmd:num:arg | | app:cmd:stat:num:data |
| Name | (MSB:LSB) | Description | (MSB:LSB) |
| MP3_{—} | 0001:00:000003:0000 | Returns the track ID of | 0001:00:SSSSSS:000087:X |
| GET_{—} | NN | track number #NN = | _{1.}.X₁₃₅ |
| TRACK_{—} | | 135 ASCII bytes. | (X_{1.}X₁₃₅ = 135 tag character |
| TAG_INFO | | | bytes packed into 45 24 bit |
| | | | words) |
| MP3_{—} | 0001:01:000000 | Returns the play state | 0001:01:SSSSSS:000003:X |
| GET_{—} | | i.e. 0 = PLAYING, | XXXXX |
| PLAY_{—} | | 1 = STOPPED, 2 = | XXXXXX = 0(play- |
| STATE | | PAUSED. | ing), 1 (stopped), 2 (paused) |
| MP3_{—} | 0001:02:000000 | Returns TRUE(−1) if the | 0001:02:SSSSSS:000003:X |
| GET_{—} | | end of file for the current | XXXXX |
| FILE_{—} | | track has been reached. | XXXXXX = 0x000000 = EOF |
| STATE | | | FALSE |
| | | | XXXXXX = 0xffffff = EOF |
| | | | TRUE |
| MP3_{—} | 0001:03:000003:OOO | Returns the value of the | 0001:03:SSSSSS:000003:D |
| GET_{—} | OOO = parameter table | internal MP3 parameter | DDDDD |
| COMMAND | offset(valid range | with table offset number | DDDDDD = returned data) |
| | 1 . . . 44₁₀)- | OOOOOO(an unsigned | |
| | see Section. | 24 bt int) | |
| MP3_{—} | 0001:04:000006:OOO | This command allows | 0001:04:SSSSSS:000000 |
| SET_{—} | OOO:DDDDDD | the host to set the | |
| COMMAND | | writable internal | |
| | | MP3 parameters. | |
| | | OOOOOO specifies the | |
| | | internal parameter | |
| | | number(table offset), | |
| | | and DDDDDD is | |
| | | the 24 bit data | |
| | | value to be written | |
| MP3_{—} | 0001:05:000003:NNN | plays track number | 0001:05:SSSSSS:000000 |
| PLAY_{—} | NNN | NNNNNN | |
| TRACK | | | |
| MP3_{—} | 0001:06:000000 | stops the currently | 0001:06:SSSSSS:000000 |
| STOP_{—} | | playing track | |
| TRACK | | | |
| MP3_{—} | 0001:07:000000 | pauses the currently | 0001:07:SSSSSS:000000 |
| PAUSE_{—} | | playing track | |
| TRACK | | | |
| MP3_{—} | 0001:08:000000 | continues playing the | 0001:08:SSSSSS:000000 |
| CONTINUE_{—} | | currently paused track | |
| TRACK | | | |
| MP3_{—} | 0001:09:000048:DDD | sets the filename-see- | 0001:09:SSSSSS:000000 |
| OPENFILE_{—} | DDD₀. . . DDDDDD₄₇ | Section | |
| CMD | | | |
| MP3_{—} | 0001:0a:000003:DDD | fast forwards/rewinds by | 0001:0a:SSSSSS:000000 |
| FFWD_{—} | DDD | DDDDDD bytes-see | |
| CMD | | Section | |

Table 2, below, describes commands that are utilized to set/read internal parameters of a media player in the form of an exemplary MP3 player. All of the MP3 commands listed in Table 2 are controllable by reading/writing into a shared global parameter area within a DSP address space.

When the DSP core 40, as described above, has finished decoding a block of audio data, it updates operational parameters with a copy of the host parameter area. All command variables are accessed via single 24-bit word values.

For example, to set an internal MP3 decode parameter, the host device sends a MP3_Set_Comand with a parameter offset number, followed by a data value to be written. To read an internal MP3 decoder parameter, the host device sends a MP3_Get_COMMAND with the parameter offset, responsive to which a 24-bit parameter is returned.

TABLE 2

| Param | Internal | | | return |
|---|---|---|---|---|
| Offset₁₀ | MP3 variable(s) | R/W | Description | data |
| 0 | software revision | R | BCD i.e. 0x0100 = version 1.00 | 24 bit BCD |
| 1 | algorithm | R | 1 = MPEG layer 1, 2 = MPEG layer 2, | 24 bit int |
| | | | 3 = MPEG layer 3, 4 = MPEG AAC | |
| 2 | status | R | −1 = “status info not | 24 bit int |
| | | | supported”, 0 = running | |
| | | | 1 = busy(init, sync etc . . . ) | |
| 3 | error number | R | −1 = “error numbers not | 16 bit int, right |
| | | | supported”, 0 = | justified |
| | | | no errors(running) | |
| 4 | error counter | R | number of fatal errors | 24 bit unsigned int |
| | | | sunce last boot | |
| 5 | frame count | R | “sign of life” | 24 bit unsigned int |
| 6 | set left level | W | 0 = max vol, 1 = | N/A |
| | | | 1.5 dB atten, 2 = 3 dB | |
| | | | atten, 3 = 4.5 dB | |
| | | | atten etc . . . | |
| 7 | set right level | W | 0 = max vol, 1 = | N/A |
| | | | 1.5 dB atten, 2 = 3 dB | |
| | | | atten, 3 = 4.5 dB | |
| | | | atten etc . . . | |
| 8 | bit rate | R | nominal overall bitrate | 24 bit unsigned int, |
| | | | | units bits/sec. |
| 9 | PCM sample rate | R | external device sample freq | 24 bit unsigned int, |
| | | | | units HZ |
| 10 | reserved | | | |
| 11 | reserved | | | |
| 12 | mode | R | 0 = stereo, 1 = | 24 bit unsigned int |
| | | | joint stereo, 2 = dual | |
| | | | channel, 3 = L + R/2, | |
| | | | 4 = left, 5 = right, | |
| | | | 6 = customised double | |
| | | | mono splitting | |
| 13 | mode extension | R | 0 = no MS and no IS ‘joint | 24 bit unsigned int |
| | | | stereo’ 1 = IS only | |
| | | | 2 = MS only | |
| | | | 3 = MS and IS | |
| 14 | emphasis | R | 0 = none, 1 = 50/15, | 24 bit unsigned int |
| | | | 2 = CCITT J.17 | |
| 15 | bitstream | R | 0 = none, 1 = ISO | 24 bit unsigned int |
| | protection bit | | CRC enabled | |
| 16 | bitstream | R | 0 = set to zero, | 24 bit unsigned int |
| | private bit | | 1 = set to one | |
| 17 | bitstream | R | 0 = no copyright, 1 = | 24 bit unsigned int |
| | copyright bit | | copyright protected | |
| 18 | bitstream original | R | 0 = copy, | 24 bit unsigned int |
| | bit | | 1 = original | |
| 19 | reserved | | | |
| 20 | reserved | | | |
| 21 | reserved | | | |
| 22 | reserved | | | |
| 23 | reserved | | | |
| 24 | reserved | | | |
| 25 | reserved | | | |
| 26 | reserved | | | |
| 27 | reserved | | | |
| 28 | reserved | | | |
| 29 | reserved | | | |
| 30 | reserved | | | |
| 31 | reserved | | | |
| 32 | reserved | | | |
| 33 | reserved | | | |
| 34 | reserved | | | |
| 35 | Bass enhancement | W | Valid range −12 . . . 0 . . . 12 | N/A |
| | | | Default value = 0 dB gain, | |
| 36 | Bass frequency | W | Bass enhance frequency, | N/A |
| | | | Default value = 250 HZ | |
| 37 | Treble enhancement | W | Valid range −12 . . . 0 . . . 12 | N/A |
| | | | Default value = 0 dB gain, | |
| 38 | Treble frequency | W | Treble enhance frequency, | N/A |
| | | | Default value = 2500 HZ | |
| 39 | granule count | R | reset value = 0 | 24 bit unsigned |
| | | | | integer |
| 40 | Left channel meter | R | reset value = 0 | 24 bit unsigned |
| | | | | integer |
| 41 | Right channel meter | R | reset value = 0 | 24 bit unsigned |
| | | | | integer |
| 42 | Frame length in bits | R | reset value = 0 | 24 bit unsigned |
| | | | | integer |
| 43 | Bitstream buffer data | R | reset value = 0x60 | 24 bit unsigned |
| | demand for input buffer | | | integer |
| 44 | PCM space required in | R | reset value = 0x60 | 24 bit unsigned |
| | output buffer | | | integer |

In an exemplary embodiment of the present invention, a command set is also available to a host device to control the media IC 22, which includes the DSP core 40. Table 3, below, describes a list of exemplary commands that may be available to a host device.

TABLE 3

| | Coding(hex) | | Response(hex) |
|---|---|---|---|
| | pp:cmd:num:arg | | pp:cmd:stat:num:data |
| Command Name | (MSB:LSB) | Description | (MSB:LSB) |
| DSP_{—} | 0000:00:000000 | requests the DSP sys- | 0000:00:SSSSSS:000000 |
| SYS_{—} | | tem status-returned in | |
| GET_STATUS | | SS field in response | |
| DSP_{—} | | not supported | |
| SYS_{—} | | | |
| HOST_STATUS | | | |
| DSP_{—} | 0000:01:000000 | requests the DSP soft- | 0000:01:SSSSSS:000003:OORRRR |
| SYS_{—} | | ware revision-see | (RRRR = BCD revision data) |
| GET_{—} | | Section | |
| SW_ID | | | |
| DSP_{—} | 0000:02:000000 | puts DSP into stop | no reply expected |
| SYS_STOP | | mode-can only | |
| | | recover via IRQA or | |
| | | RESET. | |
| DSP_{—} | 0000:03:000000 | Puts DSP into WAIT | no reply expected |
| SYS_WAIT | | mode-can recover via | |
| | | any host command. | |
| DSP_{—} | | no longer supported- | |
| SYS_{—} | | see new functions | |
| WRITE_MEM | | DSP_WRITE_{—} | |
| | | X_MEM | |
| | | DSP_WRITE_{—} | |
| | | Y_MEM | |
| | | DSP_WRITE_{—} | |
| | | P_MEM | |
| DSP_{—} | | no longer supported- | |
| SYS_{—} | | see new function | |
| READ_MEM | | DSP_READ_{—} | |
| | | X_MEM | |
| | | DSP_READ_{—} | |
| | | Y_MEM | |
| | | DSP_READ_{—} | |
| | | P_MEM | |
| DSP_{—} | | not supported | |
| SYS_{—} | | | |
| WRITE_REG | | | |
| DSP_{—} | | not supported | |
| SYS_{—} | | | |
| READ_REG | | | |
| DSP_{—} | | not supported | |
| CMD_IF_{—} | | | |
| RESET | | | |
| DSP_{—} | 0000:04:000003:XXXXXX | This command causes | 0000:04:SSSSSS:000000 |
| TERMINATE_{—} | (XXXXXX = app number a 24 | the DSP application | |
| AND_{—} | it unsigned int) | with application number | |
| UNLOAD_APP | | XXXXXX to terminate. | |
| DSP_{—} | 0000:05:000003:XXXXXX | This command invokes | 0000:05:SSSSSS:000000 |
| LOAD_{—} | (XXXXXX = app number | the DSP app loader | |
| AND_{—} | a 24 bit unsigned int) | function. The DSP uses | |
| LAUNCH_APP | | the app number to | |
| | | reference the | |
| | | application code start | |
| | | address in flash. | |
| DSP_{—} | 0000:06:000000 | returns the number of | 0000:06:SSSSSS:000003:nnnnnn |
| READ_{—} | | tracks on the MMC | (nnnnnn = 24 bit unsigned int) |
| NUM_{—} | | | |
| MMC_TRACKS | | | |
| DSP_{—} | 0000:07:000000 | returns the number of | 0000:07:SSSSSS:000003:nnnnnn |
| READ_{—} | | tracks in flash | (nnnnnn = 24 bit unsigned int) |
| NUM_{—} | | | |
| FLASH_{—} | | | |
| TRACKS | | | |
| DSP_{—} | 0000:08:000000 | returns the current | 0000:08:SSSSSS:000003:ffffff |
| GET_{—} | | audio format | (ffffff = format type = |
| AUDIO_{—} | | | unsigned 24 bit int)-see Section |
| FORMAT_{—} | | | |
| TYPE | | | |
| DSP_{—} | 0000:09:000006:AAAAAA | DSP does: | 0000:09:SSSSSS:000000 |
| WRITE_{—} | DDDD:DD | move DDDDDD,a | |
| X_MEM | AAAAAA = | move #AAAAAA,r0 | |
| | 24 bit address | move a,x:(r0) | |
| | DDDDDD = 24 bit | | |
| DSP_{—} | 0000:0A:000006:AAAAAA: | DSP does: | 0000:0A:SSSSSS:000000 |
| WRITE_{—} | DDDD:DD | move DDDDDD,a | |
| Y_MEM | AAAAAA = 24 bit address | move #AAAAAA,r0 | |
| | DDDDDD = 24 bit int data | move a,y:(r0) | |
| DSP_{—} | 0000:0B:000006:AAAAAA: | DSP does: | 0000:0B:SSSSSS:000000 |
| WRITE_{—} | DDDD:DD | move DDDDDD,a | |
| P_MEM | AAAAAA = 24 bit address | move #AAAAAA,r0 | |
| | DDDDDD = 24 bit int data | move a,p:(r0) | |
| DSP_{—} | 00000:0C:000003:AAAAAA | DSP does: | 0000:0C:SSSSSS:000003:DDDDD D |
| READ_{—} | | move #AAAAAA,r0 | (DDDDDD = 24 bit returned data |
| X_MEM | | move x:(r0),a | word) |
| | | return a | |
| DSP_{—} | 0000:0D:000003:AAAAAA | DSP does: | 0000:0D:SSSSSS:000003:DDDDD D |
| READ_{—} | | move #AAAAAA,r0 | (DDDDDD = 24 bit returned data |
| Y_MEM | | move y:(r0),a | word) |
| | | return a | |
| DSP_{—} | 0000:0E:000003:AAAAAA | DSP does: | 0000:0E:SSSSSS:000003:DDDDD D |
| READ_{—} | | move #AAAAAA,r0 | (DDDDDD = 24 bit returned data |
| P_MEM | | move p:(r0),a | word) |
| | | return a | |
| DSP_{—} | 0000:0F:000003:00GGDD | writes DD to GPIO | 0000:0F:SSSSSS:000000 |
| WRITE_{—} | | number (GG >> 8). | |
| GPIO | | N.B. only the LSB of | |
| | | the DD byte is actually | |
| | | used e.g. | |
| | | 0000:17:000003:000388 | |
| | | writes a logic 0 to GPIO | |
| | | pin 3. | |
| DSP_{—} | 0000:10:000003:0000GG | reads GPIO pin GG | 0000:10:SSSSSS:000003:DDDDDD |
| READ_{—} | | e.g. | (DDDDDD = 24 bits returned but only |
| GPIO | | 0000:18:000003:000002 | the LSB is signidicant bits 1 . . . 23 are |
| | | returns GPIO pin 2's | set to zero. |
| | | value | |
| DSP_{—} | 0000:11:000003:00GGDD | configures GPIO pin | 0000:11:SSSSSS:000000 |
| CONFIG_{—} | | GG as input or out- | |
| GPIO | | put. The LSB of the DD | |
| | | byte is used as:- | |
| | | LSB = 0 = output, | |
| | | LSB = 1 = input | |
| | | e.g. | |
| | | 0000:19:000003:000401 | |
| | | configures GPIO pin 4 | |
| | | as an input | |
| | | (N.B. only GPIO pins | |
| | | 0, 1, 2 and 8 are con- | |
| | | trollable from the | |
| | | host) all other values | |
| | | will be ignored. | |
| DSP_{—} | 0000:12:000000 | returns the 128 bit | 0000:12:SSSSSS:0000012:0000nn: |
| READ_{—} | | MMC CID register data | nnnnnn:nnnnnn:nnnnnn:nnnnnn:nnn |
| MMC_{—} | | right justified | nnn_{lsb} |
| CID_{—} | | (i.e. left most 16 bits | |
| REG | | are zero padded) | |
| DSP_{—} | 0000:13:000000 | returns the 128 bit | 0000:13:SSSSSS:0000012:0000nn: |
| READ_{—} | | MMC CSD register | nnnnnn:nnnnnn:nnnnnn:nnnnnn:nnn |
| MMC_{—} | | data right justified | nnn_{lsb} |
| CSD_{—} | | (i.e. left most 16 bits | |
| REG | | are zero padded) | |
| DSP_{—} | 0000:14:000000 | returns total MMC | 0000:14:SSSSSS:000006:DDDDDD: |
| GET_{—} | | memory size in bytes | DDDDDD |
| TOTAL_{—} | | | (DDDDDDDDDDDD = 48 bit |
| MMC_{—} | | | unsigned int) |
| MEM_SIZE | | | |
| DSP_{—} | 0000:15:000000 | returns total MMC free | 0000:15:SSSSSS:000006:DDDDDD: |
| GET_{—} | | memory in bytes | DDDDDD |
| FREE_{—} | | | (DDDDDDDDDDDD = 48 bit |
| MMC_MEM | | | unsigned int) |
| DSP_{—} | 0000:16:000000 | resets the MMC card- | 0000:16:SSSSSS:000000 |
| MMC_RESET | | pass/fail result is | |
| | | returned in system- | |
| | | status word | |
| DSP_{—} | 0000:17:000003:NNNNNN | reads a block of 512 | 0000:17:SSSSSS:0000201:word₁. . . |
| READ_{—} | NNNNNN = blk num = | bytes from the MMC | word₁₇₁ |
| MMC_{—} | 24 bit unsigned int) | | (bytes are packed 3 per 24 bit word- |
| BLOCK | | | the 2 left most bytes are zero |
| | | | padded) |
| DSP_{—} | 0000:18:000204:BBBBBB: | writes a block of 512 | 0000:18:SSSSSS:000000 |
| WRITE_{—} | word₁ . . . word₁₇₁ | bytes to MMC block | |
| MMC_BLOCK | (= the right most byte of | BBBBBB | |
| | word 171 is zero padded) | | |
| DSP_{—} | 0000:19:000006:SSSSSS: | erases block command | 0000:19:SSSSSS:000000 |
| MMC_{—} | EEEEEE | | |
| ERRASE_{—} | (SSSSSS = start block | | |
| BLOCKS | number, EEEEEE = end | | |
| | block number, both 24 bit | | |
| | unsigned quantities) | | |
| DSP_MUTE | 0000:1A:000000 | mute track | 0000:1A:SSSSSS:000000 |
| DSP_UNMUTE | 0000:1B:000000 | unmute track | 0000:1B:SSSSSS:000000 |
| DSP_{—} | 0000:1C:000000 | returns information | 0000:1C:SSSSSS:000009:XXXXXX: |
| GET_{—} | | about which apps are | YYYYYY:ZZZZZZ |
| APPS_{—} | | loaded. | (XXXXXX = app control word, bit0(LSB) = |
| INFO | | | system bit app, bit 1 = MPS etc . . . |
| | | | 1 = loaded in RAM, 0 = not loaded. |
| | | | YYYYYY and ZZZZZZ words used for |
| | | | future expansion) |
| DSP_{—} | 0000:1D:000003:NNNNNN | returns information | 0000:1D:SSSSSS:DDDDD₀ . . . |
| GET_{—} | (NNNNNN = track number, | about the track number- | DDDDDD_{N} |
| TRACK_INFO | treated as a 24 bit unsigned | see Section | |
| | int) | | |
| DSP_{—} | 0000:1E:000003:MMMMMM | see-Section | 0000:1E:SSSSSS:000006:DDDDD |
| DEBUG_{—} | | | D_{0.1‘} |
| GETDIR | | | |
| DSP_{—} | 0000:1F:000006:MMMMMM: | see-Section | 0000:1F:SSSSSS:000007:DDDDDD |
| DEBUG_{—} | IIIIII | | 0 . . . 6 |
| GETFILE | | | |
| DSP_{—} | 0000:20:000003:IIIIII | see-Section | 0000:20:000206:SSSSSS:EEEEEE: |
| DEBUG_{—} | | | NNNNNN:DDDDDD_{0 . . . NNNNNN} |
| GETBUF | | | |
| DSP_{—} | 0000:21:000003:MMMMMM: | see-Section | 0000:21:SSSSSS:000000: |
| DEBUG_{—} | IIIIII | | |
| SETDIR | | | |
| DSP_{—} | 0000:22:000003:MMMMM M | moves up a directory | 0000:22:SSSSSS:000000 |
| DEBUG_{—} | (MMMMMM = media type) | from the current directroy | |
| GOTO_{—} | | | |
| PARENT_{—} | | | |
| DIR | | | |
| DSP_{—} | 0000:23:000003:MMMMM M | moves to root dir of the | 0000:23:SSSSSS:000000 |
| DEBUG_{—} | (MMMMMM = media type) | specified media | |
| GOTO_{—} | | | |
| ROOT_DIR | | | |
| Used by SSL only | | | |
| for debug | | | |

Table 4, below, describes the field information conveyed in a 24-bit DSP status response to commands listed above in Table 3.

TABLE 4

| bit | description | meaning |
|---|---|---|
| 0 (LSB) | DSP ready | 0 = not ready, |
| | | 1 = ready to received |
| | | commands from host |
| 1, 2 | response to last command | b2, b1 |
| | | 0 0 last command |
| | | executed OK |
| | | 0 1 error occurred |
| | | executing last command |
| | | 1 0 last command was |
| | | not executed |
| | | 1 1 reserved |
| 3, 4, 5, 6, 7 | self diagnostic results | reserved |
| 8 . . . 23 (MSB) | undefined | undefined |

The above “read DSP audio format” command returns audio format information for a current track, according to Table 5, below.

TABLE 5

| Format No. | Format |
|---|---|
| 0 | unknown format |
| 1 | PCM |
| 2 | MP3 |
| 3 | Advanced Audio Coding (AAC) |
| 4 | Windows Media Audio (WMA) |
| 5 | Real Audio |
| 6 | Dolby Digital AC-3 |
| 7 | DTS |
| 8 | DVD-Audio (MLP) |
| 9 | QDesign |

A “get track info” command supplies a 24-bit integer (the track number) to the DSP core 40, responsive to which the DSP core 40 reads a play list file, and returns the information set out below in Table 6.

TABLE 6

| | | max num |
|---|---|---|
| data returned | data type | data elements |
| track duration | null terminated string | 9 packed chars |
| song info(artist + title) | null terminated string | 129 packed chars |
| filename | null terminated string | 12 packed chars |
| | | (8.3 format) |
| associated application | unsigned 24 bit integer | 1 unsigned int |
| number | | |

Note also that embodiments of the present description may be implemented not only within a physical circuit (e.g., on semiconductor chip) but also within machine-readable media. For example, the circuits and designs discussed above may be stored upon and/or embedded within machine-readable media associated with a design toll used for designing semiconductor devices. Examples include a net list formatted in the VHSIC Hardware Description Language (VHDL) language, Verilog language or SPICE language. Some net list examples include: a behavioral level net list, a register transfer level (RTL) net list, a gate level net list and a transistor level net list. Machine-readable media also include media having layout information such as a GDS-II file. Furthermore, net list files or other machine-readable media for semiconductor chip design may be used in a simulation environment to perform the methods of the teachings described above.

It is also to be understood that embodiments of this invention may be used as or to support a software program executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Thus, an integrated battery and media decoder for a portable host device, and methods of operating and manufacturing the same, have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. An integrated accessory for a host device, the accessory including:
a media decoder operationally to decode an encoded media file;
a battery coupled to the media decoder operationally to provide power to the media decoder; and
a connector electrically and removably to couple the accessory to a host device,
wherein the battery is coupled to the connector to allow the battery operationally to provide power to the host device.

2. The integrated accessory of claim 1 wherein the media decoder includes an audio decoder.

3. The integrated accessory of claim 1 including a media encoder to encode a media signal.

4. The integrated accessory of claim 1 wherein the battery, the media decoder, and the connector are integrated within a housing configured to be removably coupled to the host device.

5. The integrated accessory of claim 1 wherein the host device is a portable device.

6. The integrated accessory of claim 5 wherein the portable device includes any one of a group of devices including a portable computer, a mobile telephone, a personal digital assistant (PDA), a watch and a camera.

7. The integrated accessory of claim 1 including a power converter to convert power received from the battery to a voltage appropriate for the media decoder.

8. The integrated accessory of claim 1 wherein the connector provides a control interface whereby data communications are operationally facilitated between the media decoder and the host device.

9. The integrated accessory of claim 8 wherein the control interface includes an I²C interface.

10. The integrated accessory of claim 8 wherein the data communications include commands provided from the host device to the media decoder.

11. The integrated accessory of claim 10 wherein the commands include control commands to control operation of the media decoder.

12. The integrated accessory of claim 11 wherein the media decoder is a compressed media player, and the control commands are to control operation of the compressed media player.

13. The integrated accessory of claim 11 wherein the media decoder includes a digital signal processor, and the control commands are to control operation of the digital signal processor.

14. The integrated accessory of claim 10 wherein the commands include parameter set commands to set parameters of the media decoder.

15. The integrated accessory of claim 14 wherein the media decoder is a compressed media player, and the parameter set commands are to set parameters of the compressed media player.

16. The integrated accessory of claim 14 wherein the media decoder includes a digital signal processor, and the parameter set commands are to set parameters of the digital signal processor.

17. The integrated accessory of claim 10 wherein the commands include parameter read commands to read parameters of the media decoder.

18. The integrated accessory of claim 7 wherein the media decoder is a compressed media player, and the parameter read commands are to read parameters of the compressed media player.

19. The integrated accessory of claim 17 wherein the media decoder includes a digital signal processor, and the parameter read commands are to read parameters of the digital signal processor.

20. The integrated accessory of claim 1 wherein the connector is coupled operationally to provide compressed media data, received from the host device, for storage to a memory associated with the media decoder.

21. The integrated accessory of claim 8 wherein the media decoder operationally provides data to the host device via the control interface.

22. The integrated accessory of claim 21 wherein the data includes data concerning the media decoder provided responsive to a command received at the media decoder from the host device via the control interface.

23. The integrated accessory of claim 22 wherein the data is operationally to be displayed on a display screen of the host device.

24. The integrated accessory of claim 1 wherein the connector includes a media interface whereby for the media decoder operationally provides decoded media data to the host device.

25. The integrated accessory of claim 24 wherein the media data is in a digital form, and is operationally provided to a digital-to-analog converter (DAC) within the host device.

26. The integrated accessory of claim 1 including a digital-to-analog converter (DAC) coupled to the media decoder to receive decoded media data from the media decoder, and to generate an analog output based on the decoded media data.

27. The integrated accessory of claim 26 including an output jack coupled operationally to receive the analog output from the digital-to-analog converter.

28. The integrated accessory of claim 1 including a memory associated with the media decoder to store media data.

29. The integrated accessory of claim 28 wherein the media data is in a compressed format.

30. The integrated accessory of claim 29 wherein the compressed format includes any one of the MP3, AAC, Microsoft Windows Media, Qdesign Media, and Audible.com formats.

31. The integrated accessory of claim 28 wherein the memory is to store at least one decompression algorithm.

32. The integrated accessory of claim 28 wherein the memory includes a non-volatile memory to store the at least one decompression algorithm.

33. The integrated accessory of claim 32 wherein the non-volatile memory is to store the media data in addition to the at least one decompression algorithm.

34. The integrated accessory of claim 1 wherein integrated accessory is configured to receive a removable memory card to store media data.

35. The integrated accessory of claim 28 including an external interface coupled to the memory, the external interface to provide compressed media data for storage to the memory.

36. The integrated accessory of claim 35 wherein the external interface includes a USB interface.

37. The integrated accessory of claim 1 wherein the media decoder includes a programmable digital signal processor (DSP) core.

38. The integrated accessory of claim 37 wherein program code for the DSP is stored within a memory associated with the media decoder, and uploaded by the DSP core on power up.

39. A method to operate an integrated accessory for a host device, the method including:
utilizing a media decoder operationally to decode an encoded media file;
utilizing a battery coupled to the media decoder operationally to provide power to the media decoder; and
utilizing a connector electrically and removably to couple the accessory to a host device,
wherein the battery is coupled to the connector to allow the battery operationally to provide power to the host device.

40. The method of claim 39 wherein the media decoder includes an audio decoder.

41. The method of claim 39 including utilizing a media encoder to encode a media signal.

42. The method of claim 39 wherein the battery, the media decoder, and the connector are integrated within a housing configured to be removably coupled to the host device.

43. The method of claim 39 wherein the host device is a portable device.

44. The method of claim 39 including utilizing a power converter to convert power received from the battery to a voltage appropriate for the media decoder.

45. The method of claim 39 including utilizing the connector to provide a control interface whereby data communications are operationally facilitated between the media decoder and the host device.

46. The method of claim 45 wherein the data communications include commands provided from the host device to the media decoder.

47. The method of claim 46 wherein the commands include control commands, the method including controlling operation of the media decoder utilizing the control commands.

48. The method of claim 47 wherein the media decoder is a compressed media player, and the control commands are to control operation of the compressed media player.

49. The method of claim 47 wherein the media decoder includes a digital signal processor, and the control commands are to control operation of the digital signal processor.

50. The method of claim 46 wherein the commands include parameter set commands to set parameters of the media decoder.

51. The method of claim 50 wherein the media decoder is a compressed media player, the method including setting parameters of the compressed media player utilizing the parameter set commands.

52. The method of claim 39 including providing compressed media data, received from the host device, via the connector for storage to a memory associated with the media decoder.

53. The method of claim 39 including providing data from the media decoder to the host device via the control interface.

54. The method of claim 53 wherein the data includes data concerning the media decoder, the method including providing the data responsive to a command received at the media decoder from the host device via the control interface.

55. The method of claim 39 including providing decoded media data to the host device via a media interface included within the connector.

56. The method of claim 55 wherein the media data is in a digital form, and the method including providing the media data to a digital-to-analog converter (DAC) within the host device.

57. The method of claim 39 wherein the integrated accessory includes a digital-to-analog converter (DAC) coupled to the media decoder to receive decoded media data from the media decoder, the method including generating an analog output based on the decoded media data within the integrated accessory.

58. The method of claim 57 wherein the integrated accessory includes an output jack, the method including providing the analog output from the digital-to-analog converter to the output jack.

59. The method of claim 39 wherein the integrated accessory includes a memory, the method including storing at least one decompression algorithm in the memory.

60. The method of claim 59 including storing media data in the memory in addition to the at least one decompression algorithm.

61. The method of claim 59 including storing program code for the media decoder within the memory, and uploading the program code to the media decoder on power up.

62. A method of manufacturing an integrated accessory for a host device, the method including:
providing a media decoder operationally to decode an encoded media file;
coupling a battery to the media decoder operationally to provide power to the media decoder; and
coupling the battery to a connector, the connector electrically and removably to coupled the accessory to a host device,
wherein the battery is coupled to the connector to allow the battery operationally to provide power to the host device.

63. The method of claim 62 including coupling the battery to a media encoder, the media encoder to encode a media signal.

64. The method of claim 62 including accommodating the battery, the media decoder, and the connector within a housing configured to be removably coupled to the host device.

65. The method of claim 62 including coupling a power converter to the battery, the power converter to convert power received from the battery to a voltage appropriate for the media decoder.

66. The method of claim 62 including coupling the connector to a memory, associated with the media decoder, of the integrated accessory, the connector operationally to provide compressed media data, received from the host device, for storage to the memory.

67. The method of claim 62 including coupling a digital-to-analog converter (DAC) to the media decoder, the DAC to receive decoded media data from the media decoder, and to generate an analog output based on the decoded media data.

68. The method of claim 67 including coupling an output jack to receive the analog output from the digital-to-analog converter.

69. The method of claim 62 including configuring the integrated accessory to receive a removable memory card to store media data.

70. The method of claim 62 including coupling an external interface to a memory of the integrated accessory, the external interface to provide compressed media data for storage to the memory.

71. The method of claim 70 wherein the external interface includes a USB interface.

72. An integrated accessory for a host device, the accessory including:
first means operationally for decoding an encoded media file;
second means, coupled to the first means, for operationally providing power to the first means;
third means for electrically and removably coupling the accessory to a host device,
wherein the second means is coupled to the third means to allow the second means operationally to provide power to the host device.
